(19) United States
(12) Patent Application Publication
(10) Pub. No.: US 2005/0218608 A1
(43) Pub. Date: Oct. 6, 2005

(54) Clamping chuck

(76) Inventor: Johann Taglang, Medlingen (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/513,228

(22) PCT Filed: May 2, 2003
(86) PCT No.: PCT/DE03/01416

§ 371 Date: Jun. 3, 2005

(30) Foreign Application Priority Data
May 2, 2002 (DE) 102 19 534.2

(51) Int. Cl. B23B 31/16

(52) U.S. Cl. 279/121

(57) ABSTRACT

The invention relates to a clamping chuck comprising several base jaws (3) which are radially guided in a chuck body (2) and on which a top clamping jaw (5) is detachably fixed. At least one connecting part (6) which is radially open on one side and is provided with a first contact surface (9) that is inclined relative to the axis of the chuck is configured on the top clamping jaw (5). At least one coupling part (8) which is provided with a second contact surface (9) that is inclined in a manner corresponding to the first contact surface (7) is disposed on the base jaw (3) so as to cooperate with the connecting part (6).

### The invention relates to a chuck with a plurality of jaw mounts that are radially displaceable in a chuck body and on which jaws are removably mounted.

Such chucks are widely known in practice, the removability of the jaws on the mounts allowing the jaws to be changed so that thy can be switched with jaws particularly suited for the particular work setup and workpiece. The releasable mounting is normally effected by bolting, which produces a solid and very strong connection but which has the disadvantage that the time necessary to change the jaws is considerable and during this long time the machine with the chuck is out of service.

It is an object of the invention to provide a chuck of this type where the jaws can be quickly and purely manually switched on the mounts without the use of tools, and without reducing the safety or strength of the mounting connection.

This objects is achieved according to the invention in a chuck of the above-described type wherein each jaw is formed with at least one mounting part that is open radially in one direction and that has a first contact face extending at an angle to a chuck axis, and that at least one coupling part is provided on each jaw mount that has a second coupling face angled complementarily to the respective first contact face and that coacts with the respective mounting part.

This chuck has the advantage that, according to the desired object, jaws can be changed on the jaw mounts without the use of tools purely manually, since the jaws are secured by an interfit of the mounting part with the coupling part, this interfit being done and undone by a radial sliding of the jaws. The inclination of the first contact faces and of the second contact faces thus serves to prevent tipping of the jaws during the clamping operation.

It is further within the scope of the invention that the jaws each have two such radially open mounting parts radially spaced from each other to form a mounting-part pair of which at least one of the mounting parts has the first contact face angled to the chuck axis, and that the jaw mount has two such coupling parts forming a coupling-part pair. With this embodiment there is the advantage of a more stable and stronger connection between the jaws and the jaw mounts so that an unneeded long guide is unnecessary for one of the mounting parts.

A particularly advantageous embodiment of the invention is characterized in that the coupling parts are formed with respective such second contact faces that are inclined oppositely to the jaw axis. As a result of this construction it is possible to mount the jaws on the jaw mounts in two 180° opposite orientations so that it is possible to hold a workpiece internally or externally.

A further increase in the strength of the connection between the jaws and the jaws mounts is achieved when two such mounting-part pairs are provided on edges of the jaws, which does not change the advantage that a purely manual switching of the jaws can be done quickly.

It has been shown to be advantageous when one of the mounting parts of each mounting-part pair is formed as a hook and the other mounting part is formed as an undercut with the angled first contact face. This embodiment is advantages in that the hook forms a solid connection on sliding of the jaw radially onto the jaw mount and the first and second contact faces draw the jaws axially against the jaw mounts. In this regard it is advantageous is when each jaw mount has a coupling-part pair with coupling parts formed by pins, the coupling parts also including the hooks as well as the undercuts.

A further preferred embodiment is characterized in that a pin urged by a spring toward the respective jaw is guided in each jaw mount and is actuated when the respective jaw is mounted on the jaw mount. This pin pushes the jaws with the first contact faces against the second contact faces of the jaw mounts so that the jaws are always properly oriented before a large clamping force is applied and the first and the second contact faces are pressed together with great pressure.

It is advantageous when each jaw is formed with a seat in which the pin is engageable, the pin seat preferably being formed with a conical end.

The pin is longitudinally shiftable in its guide in the respective jaw mount by means of an externally accessible screw so that this pin can actively be adjusted against the force of the spring which is necessary in order to move the pin out of the pin seat to change the jaws. With regard to the simplicity of construction, it is advantageous when the screw has an eccentric projection that engages in the pin. An indicator for the proper position if the pins is achieved when the screw is provided with seats in which a spring-loaded latch element engages in end positions of the eccentric projection.

The invention is described in more detail in the following with reference to the embodiments shown in the drawing; therein:

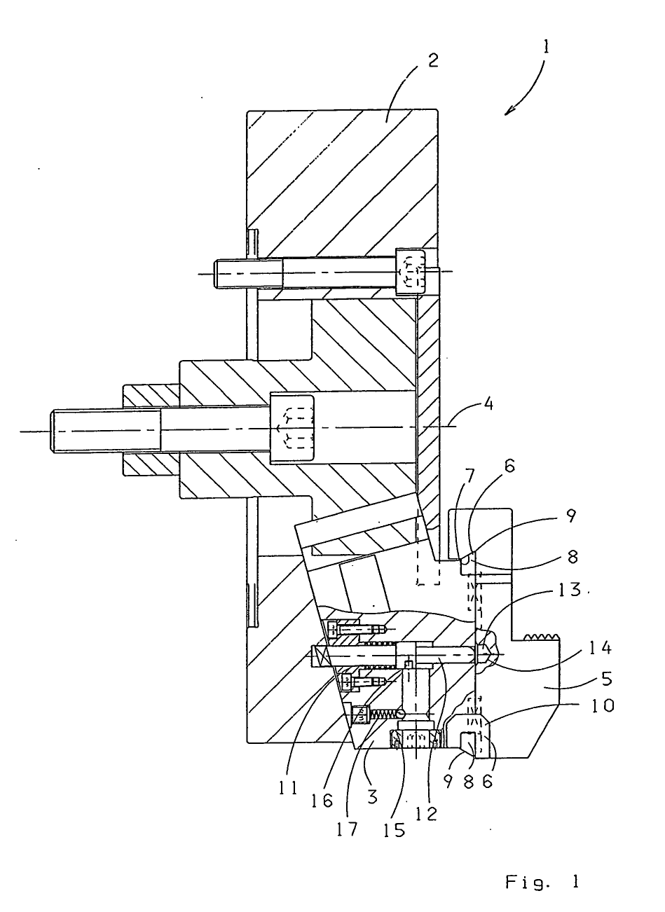

FIG. 1 is a longitudinal section through a power-actuated chuck in an open position with angled jaw mounts for outside-grip jaws;

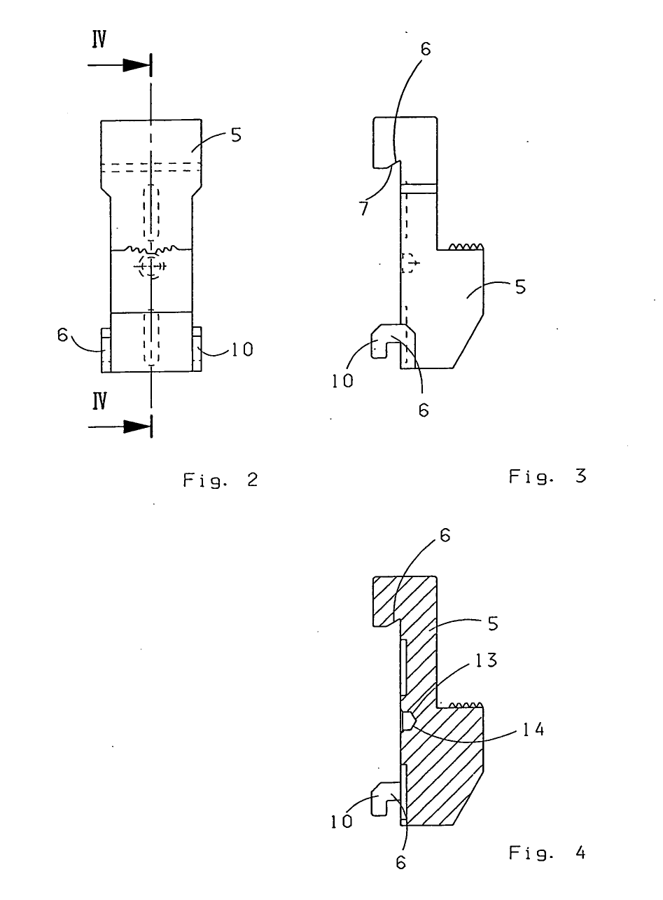

FIG. 2 is a front view of a single jaw;

FIG. 3 is the FIG. 2 jaw in side view;

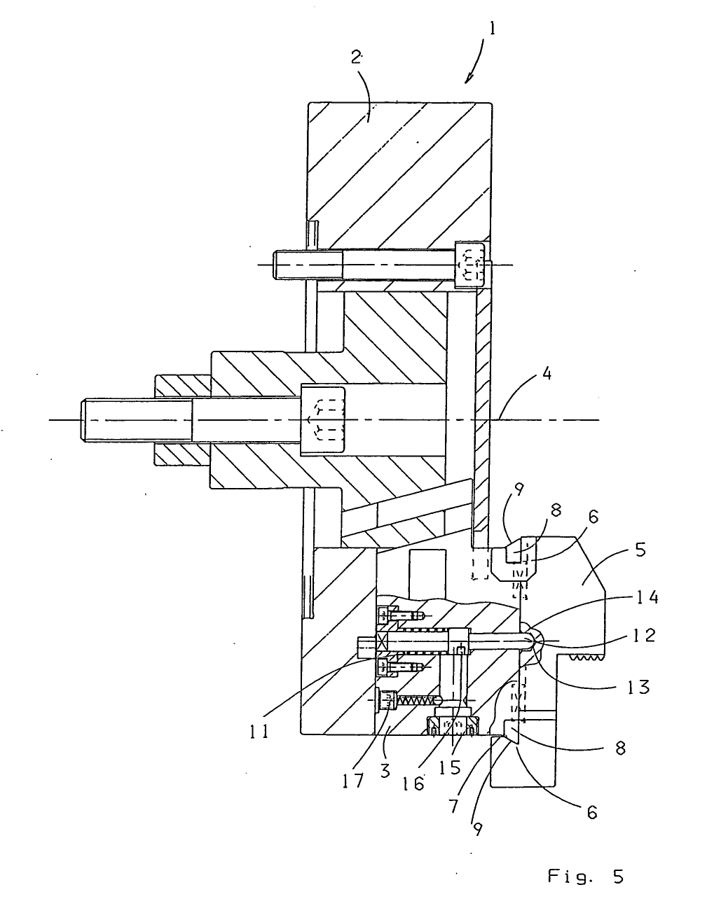

FIG. 4 is a section taken along line IV-IV of FIG. 2;

FIG. 5 is a view like FIG. 1 of a power actuated-chuck with perpendicular jaw mounts, shown with inside-grip jaws in a clamping position; and

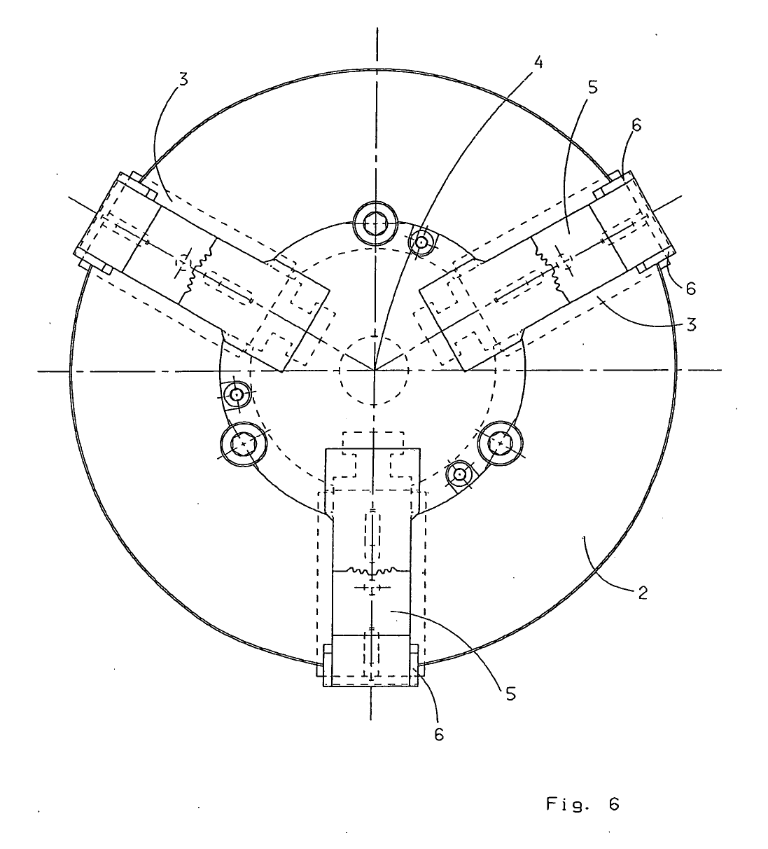

FIG. 6 is a front view of the chuck of FIG. 1.

In the drawing, FIG. 1 shows a power-actuated chuck 1 intended for use on a machining apparatus and having a plurality of jaw mounts 3 distributed angularly uniformly on a body 2 of the chuck 1, FIG. 1 showing an embodiment where the jaw mounts 3 move at an angle to a chuck axis 4 while FIG. 5 shows an embodiment with perpendicular jaw movement.

Jaws 5 are releasably secured to the jaw mounts 3, the jaws 5 each having at least one mounting part 6 open radially in one direction and having a contact face 7 extending at an angle to the jaw axis 4. In the illustrated embodiment, in particular in FIGS. 2-4, there are several mounting parts 6, here three. The jaw mounts 3 each have a number of coupling parts 8 corresponding to the number of mounting parts 6, here again four, with second contact faces 9 angled like the contact faces 7 and coacting with the respective mounting part 6.

The jaws 5 each have two mounting parts open radially in one direction and forming a mounting-part pair. One of the mounting parts 5 has the first a contact face 7 angled to the jaw axis and formed as an undercut. The other mounting part 6 of the mounting-part pair is formed as a hook 10. Two mounting-part pairs are provided on the edges of the jaw 5 so that there are in total four mounting parts of which the mounting parts 6 with the first contact faces 7 formed as an undercut are one part as shown in FIGS. 2-4, namely extending transversely all the way across the jaw 5, but without actually being formed as two physically separate mounting parts. The four coupling parts 8 are also arrayed as two coupling-part pairs.

Each of the coupling parts 8 of a coupling-part pair is formed as the second contact face 9 that is inclined oppositely to the jaw axis 4 so that the jaws 5 can be used for inside holding as in FIG. 5 or for outside holding (FIG. 1).

Each jaw mount 3 is provided with a pin 12 that is urged by a respective spring 1 toward the respective jaw 5 and that is actuated by the jaw 5, the jaw 5 having a pin seat 14 with a conical end 13 in which the pin 12 can engage. The pin 12 is longitudinally shiftable in its guide from an externally accessible screw 15 that has an eccentric projection 16 that engages the pin 12. The screw is formed with seats for a spring-loaded latch element 17 in the two end positions of the eccentric bolt 15.

1. A chuck with a plurality of jaw mounts (3) that are radially slidable in a chuck body (2) and to which jaws (5) are releasably mounted, characterized in that each jaw (5) is formed with at least one mounting part (6) that is open radially in one direction and that has a first contact face (7) extending at an angle to a chuck axis (4), and that at least one coupling part (8) is provided on each jaw mount (3) that has a second coupling face (9) angled complementarily to the respective first contact face (7) and that coacts with the respective mounting part (6).

2. The chuck according to claim 1, characterized in that the jaws (5) each have two such radially open mounting parts (6) radially spaced from each other to form a mounting-part pair of which at least one of the mounting parts (6) has the first contact face (7) angled to the chuck axis (4), and that the jaw mount (3) has two such coupling parts (8) forming a coupling-part pair.

3. The chuck according to claim 2, characterized in that the coupling parts (8) are formed with respective such second contact faces (9) that are inclined oppositely to the jaw axis (4).

4. The chuck according to claim 2, characterized in that two such mounting-part pairs are provided on edges of the jaws (5).

5. The chuck according to one of claim 2 to 4, characterized in that one of the mounting parts (6) of each mounting-part pair is formed as a hook (10) and the other mounting part (6) is formed as an undercut with the angled first contact face (7).

6. The chuck according to claim 5, characterized in that each jaw mount (3) has a coupling-part pair with coupling parts (8) formed by pins.

7. The chuck according to one of claim 1, characterized in that a pin (12) urged by a spring (11) toward the respective jaw (5) is guided in each jaw mount (3) and is actuated when the respective jaw (5) is mounted on the jaw mount (3).

8. The chuck according to claim 7, characterized in that each jaw (5) is formed with a seat (14) in which the pin (12) is engageable.

9. The chuck according to claim 8, characterized in that the pin seat (12) is formed with a conical end (13).

10. The chuck according to one of claim 7, characterized in that the pin (12) is longitudinally shiftable in its guide in the respective jaw mount (3) by means of an externally accessible screw (15).

11. The chuck according to claim 10, characterized in that the screw (15) has an eccentric projection (16) that engages in the pin (12).

12. The chuck according to claim 10, characterized in that the screw (15) is provided with seats in which a spring-loaded latch element (17) engages in end positions of the eccentric projection (16).
